(19) United States
(12) Patent Application Publication
(10) Pub. No.: US 2023/0211808 A1
(43) Pub. Date: Jul. 6, 2023

(54) RADAR-BASED DATA FILTERING FOR VISUAL AND LIDAR ODOMETRY

(71) Applicant: GM Cruise Holdings LLC, San Francisco, CA (US)

(72) Inventors: Mayur Shah, Pleasanton, CA (US); Michael Harville, San Carlos, CA (US)

(21) Appl. No.: 17/566,445

(22) Filed: Dec. 30, 2021

(51) Int. Cl. B60W 60/00; G06T 7/73; G06T 7/246; G01S 13/931; G01S 13/52; B60W 40/04

(52) U.S. Cl. CPC B60W 60/0027; G06T 7/73; G06T 7/246; G01S 13/931; G01S 13/52; B60W 40/04; G06T 2207/30252; G06T 2207/10028; G06T 2207/10048; G01S 13/865

(57) ABSTRACT

Aspects of the disclosed technology provide solutions for performing odometry and in particular, for performing odometry by filtering moving objects from a scene using sensor data. In some aspects, a process can include steps for receiving a first set of sensor data corresponding with a plurality of objects in a scene, determining one or more moving objects and one or more stationary objects from among the plurality of objects, and receiving a second set of sensor data. In some aspects, the process can further include steps for filtering the second set of sensor data to remove data associated with the one or more moving objects and generating odometry data associated with the filtered second set of sensor data. Systems and machine-readable media are also provided.

### BACKGROUND

### 1. Technical Field

The subject technology provides solutions for autonomous vehicle systems, and in particular, for localizing objects based on odometry data.

### 2. Introduction

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide safe and efficient transportation. Such tasks may require the collection and processing of large quantities of data disposed on the autonomous vehicle.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example of a system for managing one or more Autonomous Vehicles (AVs), according to some aspects of the disclosed technology.

FIG. 2 illustrates an example environment in which odometry-based object localization process can be implemented, according to some aspects of the disclosed technology.

FIG. 3 illustrates a block diagram of an example odometry system, according to some aspects of the disclosed technology.

FIG. 4 illustrates an example process of filtering radar-based odometry data, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

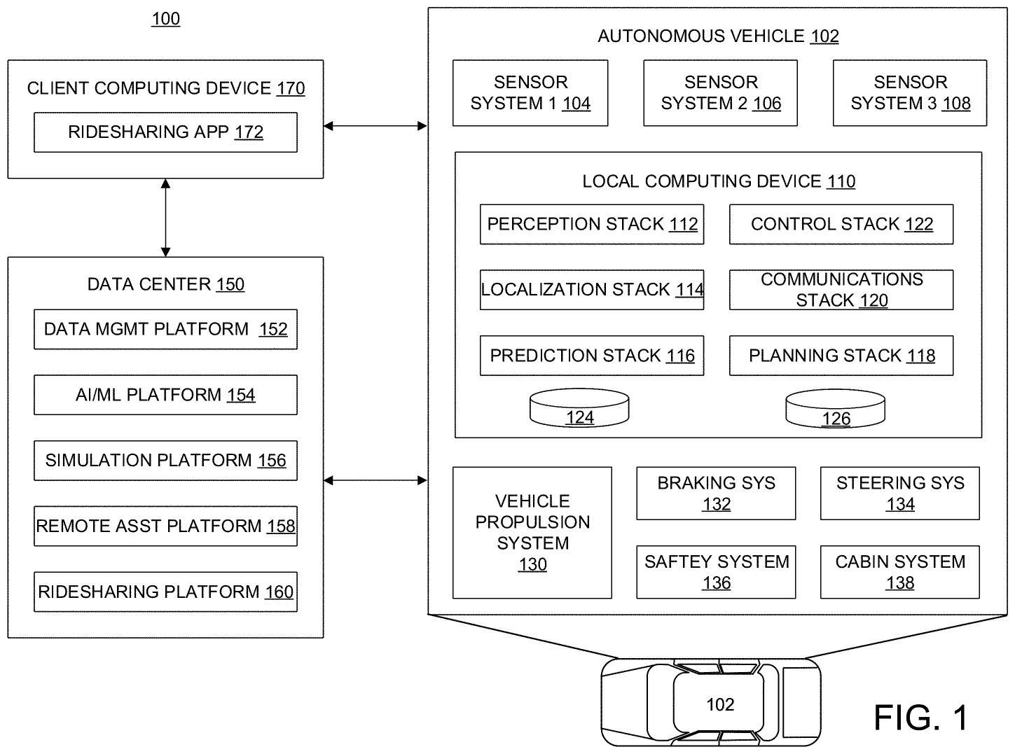

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Autonomous vehicle perception functions rely on high-accuracy localization information that provides the location of the vehicle, for example, as an absolute location and orientation within a map of some portion of the world. Some localization systems provide the relative location and orientation of the autonomous vehicle with respect to elements of the scene such as, for example, road lane markings and traffic signs, either in addition to or instead of absolute location and orientation in a map. In many such systems, the measurement of the vehicle ego-motion, i.e. the relative motion of the vehicle with respect to the environment surrounding the AV, is an important component of localization, and is often referred to as odometry. Many techniques for performing odometry based on LIDAR, camera, radar, IMUs (inertial-measurement units) and/or other sensor data may utilize one or more algorithms such as visual feature detection and tracking, LIDAR point cloud feature detection and tracking, LIDAR point cloud alignment, Kalman filtering, and/or pose graph optimization, etc. The ability to make accurate odometry and localization measurements can be degraded by the presence of moving (dynamic) objects, because the relative motion of the autonomous vehicle with respect to the static parts of the surrounding scene (e.g. the road and buildings) is different from the relative motion of the autonomous vehicle with respect to the dynamic objects. As such, a need exists to remove (filter) sensor data corresponding with dynamic objects e.g., to improve localization measurements.

Some conventional object detection and segmentation processes, for example, that are based on computer vision and/or machine-learning approaches, can have relatively high latency requirements as compared to odometry based filtering approaches. For example, computer vision or deep-learning approaches can be used to scan for and identify dynamic objects, such as moving cars, within a scene, as well as stationary objects such as buildings, road cars, etc. However, such approaches often consume around 100 milliseconds from sensing data to producing detection or segmentation output. Aspects of the disclosed technology address the foregoing limitations of conventional computer vision/deep-learning approaches by providing solutions for filtering out dynamic objects prior to performing object localization using odometry data. In some aspects, multiple sets of dynamic object detection data (such as radar data) can be collected, and used to identify and filter dynamic scene objects. Once dynamic objects (or data representing the dynamic objects) have been filtered, subsequently collected odometry data can be used to perform object localization.

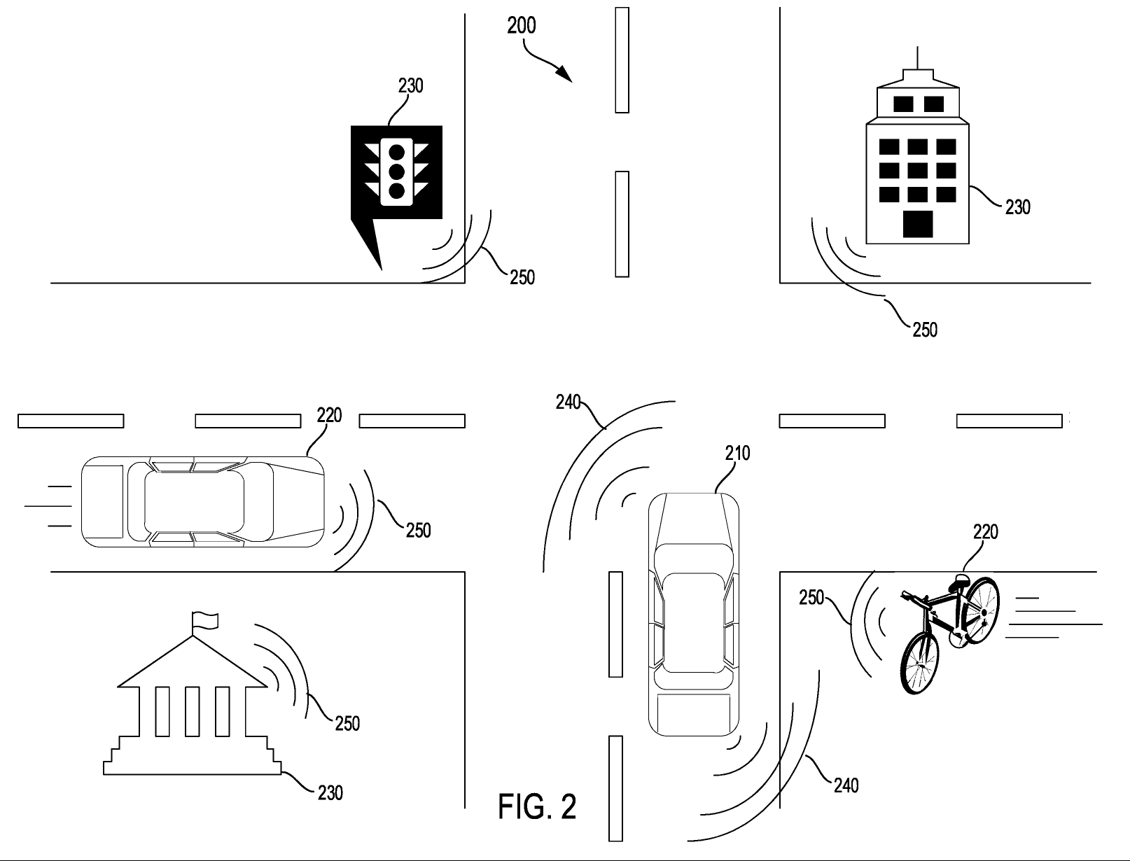

FIG. 2 illustrates an example environment in which an odometry-based localization process can be implemented. Environment 200 includes an autonomous vehicle 210 that can collect sensor data regarding about various objects in environment 200. As discussed above, sensor data can include data acquired from various AV sensors, including but not limited to one or more radar sensors, LiDAR sensors, camera sensors, thermal camera sensors, or the like. Sensor data can be collected by AV 210 at different times, and the type of collected sensor data can vary, depending on the desired implementation. By way of example, AV 210 can be configured to receive a first set of sensor data by transmitting radar signals 240 and receiving return radar signals 250 from objects 220, 230 around autonomous vehicle 210, in environment 200. Some of the objects in environment 200 may be moving objects (e.g., objects 220, 230), and some may be stationary objects 230.

In practice, sensor data, such as radar data, can be used to detect object motion (or lack thereof), e.g., by identifying a Doppler effect from return radar signals 250. For example, an autonomous vehicle that utilizes radar can detect stationary and moving objects based on the Doppler effect, which can be used to register velocities of moving objects. When an autonomous vehicle is moving, it appears that the surroundings of the autonomous vehicle are also moving. However, corrections can be performed in view of the autonomous vehicle's motion. For example, a work frame (e.g., a scene) can be generated to determine which objects are moving and which objects are stationary (e.g., based on radar data including the Doppler effect and velocities of the moving objects).

In some approaches, moving objects identified from the first set of sensor data (e.g., radar data) can be mapped into corresponding elements of a second set of sensor data (i.e., sensor data from various other sensor types). In some implementations, this mapping is achieved through well-known calibration techniques for relating extrinsic (position and orientation) relations between different sensors, as well as calibration of intrinsic properties of the various sensors. The corresponding data elements in the second set of sensor data can be removed prior to using that second set of sensor data to localize the AV 210.

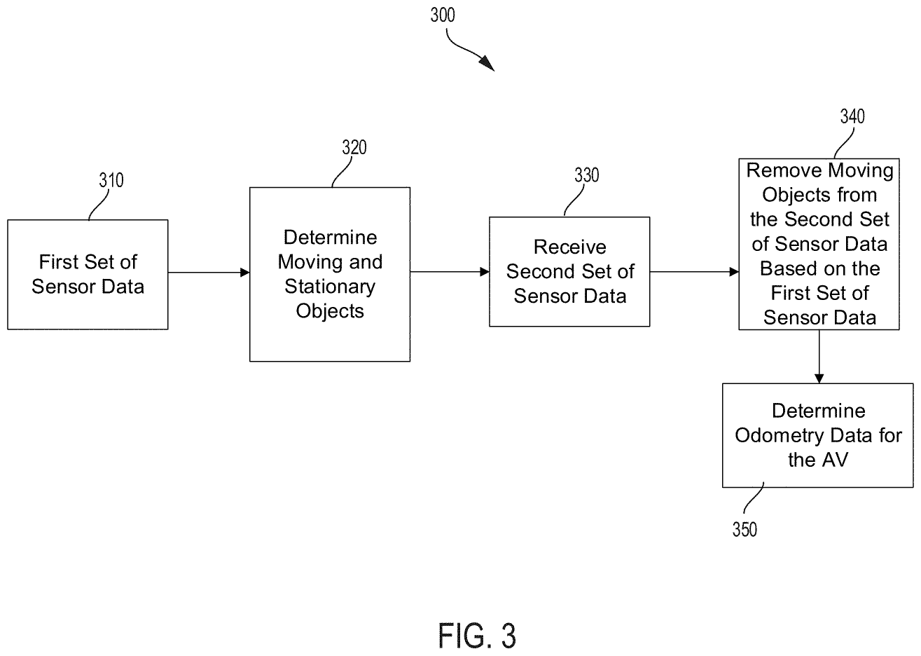

FIG. 3 illustrates an example block diagram of an odometry system 300, according to some aspects of the disclosed technology. In some implementations, the block diagram 300 (e.g., a process) can include a step 310 of receiving a first set of sensor data (e.g., radar data) corresponding with various objects within a scene of an autonomous vehicle. As indicated above, the first set of sensor data can represent moving and stationary objects in an environment around the AV. In step 320, the process 300 can include determining/identifying which objects are moving and which objects are stationary based on the first set of sensor data associated with the scene. As described above, step 320 of the process 300 can include utilizing the Doppler effect and velocities of the moving objects to determine that an object is indeed a moving object.

In step 330, a second set of sensor data is received. The second set of sensor data can include sensor data collected for the environment around the AV, for example, including representations of moving and stationary objects, such as the same moving and/or stationary objects represented in the first set of sensor data (e.g., block 310). Subsequently, the process 300 can include a step 340 for removing the moving/dynamic objects from the scene (e.g., from the second data) based on the moving object determinization/s made at block 320 based on the first set of sensor data. In such approaches, stationary objects identified at block 320 can be retained in the second set of sensor data. As a result, the filtered second set of sensor data determined in step 340 can include data representing a scene containing only stationary objects in the environment around the AV. In step 350, odometry data for the autonomous vehicle is generated based on the remaining stationary scene elements in the second set of sensor data. In various implementations, the process 300 may be performed by the autonomous vehicle, a backend server, or other computational resources.

One advantage of the present disclosure is that the latency or the amount of time it takes to perform such measurements with radar is very low (e.g., approximately tens of milliseconds). As such, the present disclosure provides an improvement on the order of one magnitude in latency (e.g., going from hundreds of milliseconds to tens of milliseconds (e.g., approximately 10-19 milliseconds).

In some implementations, once moving objects are removed from a scene, the remaining objects are stationary objects that can be tracked (e.g., using sparse feature points, dense optical flow, or recognizable patterns). For example, the present disclosure can utilize radar to perform a fast removal of moving objects from a scene so that odometry can be performed with low latency.

One of the benefits of the process 300 can include having a low latency, which is associated with utilizing radar as described herein. The process 300 can also be utilized to provide the autonomous vehicle system with additional redundancy capabilities. For example, if a camera or a sensor of the autonomous vehicle goes down, the autonomous vehicle may be unable to efficiently detect objects or people within a vicinity of the autonomous vehicle. The present disclosure accounts for such deficiencies and can still remove non-static objects from a scene and proceed with localization of the autonomous vehicle.

In some implementations, the process 300 can further include matching objects based on the odometry data that is determined in view of the second set of sensor data for the stationary objects in the scene. The process 300 can also include utilizing data from multiple sources (e.g., sensors, other lidar, radar, cameras, thermal cameras, etc.) for the matching process. For example, the closer a match, the higher a confidence rating there may be.

In some examples, the radar data that may be utilized by the autonomous vehicle as described here can include relative motion data that may be based on the Doppler effect or velocities of the moving objects in a scene.

In other examples, the process 300 can further include utilizing data from other sensors, cameras, radar, or lidar to generate odometry data of the scene. For example, the process 300 can utilize lidar data 350 and vision data (e.g., camera or sensor data) to generate odometry data of the scene of step 340.

In other implementations, the process 300 can include two stages: 1) a data filtering stage, e.g., steps 310, 320, 330 of the process 300 where moving objects can be excluded; and 2) an odometry stage (e.g., steps 340, 350 of the process 300). In the data filtering stage, it could be performed on the radar data, or data filtering can include using radar, radar and lidar, or radar, lidar, and/or cameras, etc. For example, radar can be utilized for an initial segmentation, while lidar can be utilized to check distances to perform segmentation, thereby providing a joint segmentation of radar and lidar.

In some examples, the process 300 can utilize one or more radars and information from geometry to establish a stereo camera equivalent that can also utilize knowledge of the relative positions on the autonomous vehicle to determine which objects are moving and which objects are stationary.

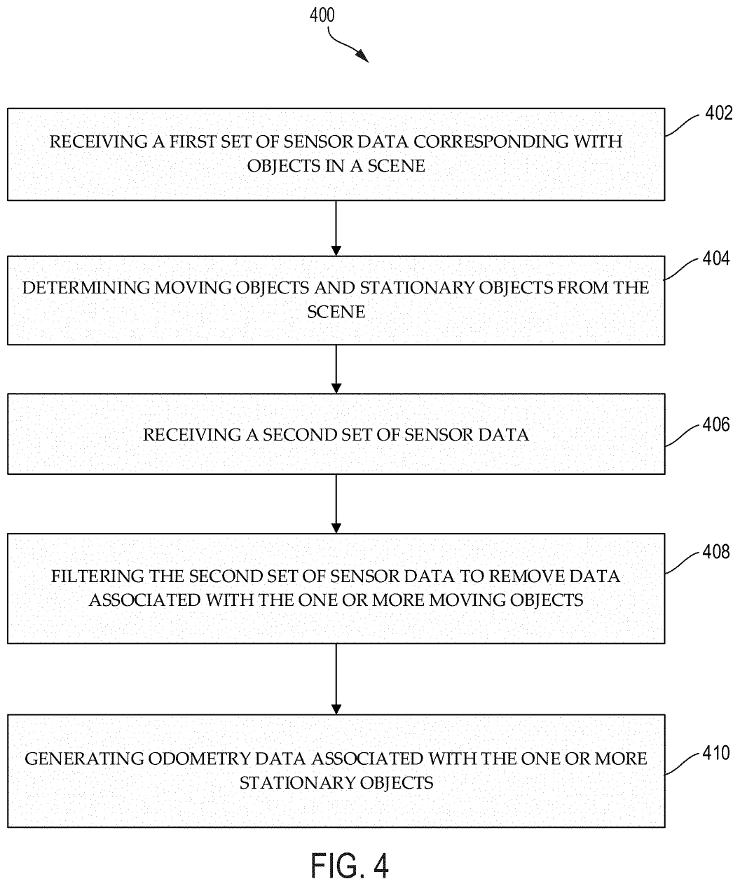

Having disclosed some example system components and concepts, the disclosure now turns to FIG. 4, which illustrates an example method 400 for filtering radar-based data for lidar odometry. The steps outlined herein are exemplary and can be implemented in any combination thereof, including combinations that exclude, add, or modify certain steps.

At step 402, method 400 can include receiving first set of sensor data corresponding with various objects in a scene. As discussed above, the objects can be various objects (e.g., vehicles, pedestrians, buildings, signage, plants and foliage, road pavement, etc.) that would surround an AV in a driving scene, such as that illustrated by environment 200. The first set of sensor data can include radar data that can be used to identify (or determine) kinematic characteristics of various objects in the scene. For example, the first set of sensor data (e.g., radar data) can be used to identify one or more moving and/or stationary objects in the scene (step 404).

At step 406, method 400 can include receiving a second set of sensor data associated with the stationary objects. In some aspects, the second set of sensor data may include visual data for the stationary objects, including but not limited to LiDAR data, camera data and/or thermal camera data, or the like.

At step 408, method 400 can include filtering the second set of sensor data to remove data associated with the one or more moving objects. In some aspects, the filtering can include aligning the first and second sensor data sets into correspondence based on, for example, calibration of the sensors used to obtain the respective sensor data sets. Further, some aspects can then include removal of portions of the aligned second set of sensor data based on their correspondence with moving objects in the first set of sensor data.

At step 410, method 400 can include generating odometry data based on the second set of sensor data associated with the stationary objects. In some aspects, generating of the lidar odometry data can include a latency of approximately 10-19 milliseconds.

The method 400 can further include generating a work frame of the scene including the moving objects and the stationary objects based on the first set of sensor data. The method 400 can further include addition of a second set of sensor data, for example camera image data and/or LIDAR data, to the work frame such that it is aligned in correspondence with the first set of sensor data. Furthermore, the method 400 can include removing the sensor data corresponding to moving objects from the scene of the work frame, for example, based on analysis of the first set of sensor data.

The method 400 can also include receiving vision data (e.g., camera image data, LiDAR data, and/or thermal camera data) of the stationary objects from the scene, the generating of the lidar odometry data being further based on the vision data of the stationary objects. The vision data of the stationary objects can be received from at least one camera.

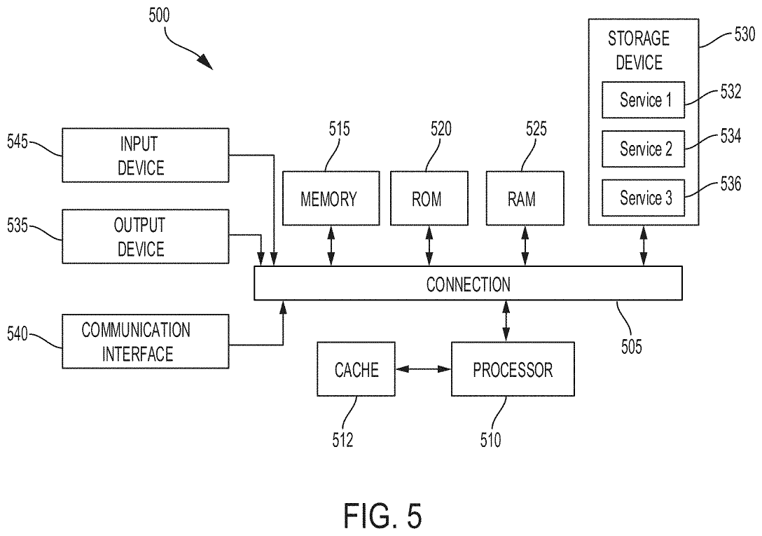

FIG. 5 illustrates an example processor-based system with which some aspects of the subject technology can be implemented. For example, processor-based system 500 that can be any computing device making up local computing device 110, data center 150, client computing device 170, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, and/or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. By way of example computer-executable instructions can be used to implement perception system functionality for determining when sensor cleaning operations are needed or should begin. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
receiving, at an autonomous vehicle system, a first set of sensor data corresponding with a plurality of objects in a scene;
determining, by the autonomous vehicle system, one or more moving objects and one or more stationary objects from among the plurality of objects, based on the first set of sensor data;
receiving, by the autonomous vehicle system, a second set of sensor data;
filtering the second set of sensor data to remove data associated with the one or more moving objects; and
generating, by the autonomous vehicle system, odometry data associated with the filtered second set of sensor data.

2. The computer-implemented method of claim 1, further comprising:
generating a work frame of the scene including the one or more moving objects and the one or more stationary objects based on the first set of sensor data.

3. The computer-implemented method of claim 1, wherein the first set of sensor data comprises radar data.

4. The computer-implemented method of claim 1, wherein the second set of data comprises one or more of: Light Detection and Ranging (LiDAR) data, camera data, radar data, thermal camera data, or a combination thereof.

5. The computer-implemented method of claim 1, wherein the first set of sensor data includes relative motion data of the one or more moving objects.

6. The computer-implemented method of claim 1, wherein the first set of sensor data includes relative motion data of the one or more stationary objects.

7. The computer-implemented method of claim 1, wherein the first set of sensor data and the second set of sensor data are received from one or more autonomous vehicle (AV) mounted sensors.

8. A system comprising:
one or more processors; and
at least one computer-readable storage medium having stored therein instructions which, when executed by the one or more processors, cause the system to:
receive a first set of sensor data corresponding with a plurality of objects in a scene;
determine one or more moving objects and one or more stationary objects from among the plurality of objects, based on the first set of sensor data;
receive a second set of sensor data;
filter the second set of sensor data to remove data associated with the one or more moving objects; and
generate odometry data associated with the filtered second set of sensor data.

9. The system of claim 8, wherein the one or more processors are further configured to:
generate a work frame of the scene including the one or more moving objects and the one or more stationary objects based on the first set of sensor data.

10. The system of claim 8, wherein the first set of sensor data comprises radar data.

11. The system of claim 8, wherein the second set of data comprises one or more of: Light Detection and Ranging (LiDAR) data, camera data, radar data, thermal camera data, or a combination thereof.

12. The system of claim 8, wherein the first set of sensor data includes relative motion data of the one or more moving objects.

13. The system of claim 8, wherein the first set of sensor data includes relative motion data of the one or more stationary objects.

14. The system of claim 8, wherein the first set of sensor data and the second set of sensor data are received from one or more autonomous vehicle (AV) mounted sensors.

15. A non-transitory computer-readable storage medium comprising instructions stored on the non-transitory computer-readable storage medium, the instructions, when executed by one or more computers or processors, cause the one or more computers or processors to:
receive a first set of sensor data corresponding with a plurality of objects in a scene;
determine one or more moving objects and one or more stationary objects from among the plurality of objects, based on the first set of sensor data;
receive a second set of sensor data;
filter the second set of sensor data to remove data associated with the one or more moving objects; and
generate odometry data associated with the filtered second set of sensor data.

16. The non-transitory computer-readable storage medium of claim 15, wherein the instructions are further configured to cause the one or more processors to:
generate a work frame of the scene including the one or more moving objects and the one or more stationary objects based on the first set of sensor data.

17. The non-transitory computer-readable storage medium of claim 15, wherein the first set of sensor data comprises radar data.

18. The non-transitory computer-readable storage medium of claim 15, wherein the second set of data comprises one or more of: Light Detection and Ranging (LiDAR) data, camera data, radar data, thermal camera data, or a combination thereof.

19. The non-transitory computer-readable storage medium of claim 15, wherein the first set of sensor data includes relative motion data of the one or more moving objects.

20. The non-transitory computer-readable storage medium of claim 15, wherein the first set of sensor data includes relative motion data of the one or more stationary objects.
